(19) United States
(12) Patent Application Publication
(10) Pub. No.: US 2016/0220059 A1
(43) Pub. Date: Aug. 4, 2016

(54) MODULATED AND CONTROLLED COOKING METHODS AND SYSTEMS FOR PERFORMING THE SAME

(71) Applicant: Palate Home, Inc., Walnut, CA (US)

(72) Inventors: Mark Wachtler, Carlsbad, CA (US); Bruce Tognazzini, Woodside, CA (US); Donald A. Norman, La Jolla, CA (US); Eric J. Norman, Walnut, CA (US)

(73) Assignee: Palate Home, Inc., Walnut, CA (US)

(21) Appl. No.: 15/021,262

(22) PCT Filed: Sep. 9, 2014
(86) PCT No.: PCT/US2014/054661

§ 371 Date: Mar. 10, 2016

Related U.S. Application Data
(60) Provisional application No. 61/876,151, filed on Sep. 10, 2013.

(51) Int. Cl. A47J 27/10; A47J 36/32

(52) U.S. Cl. CPC A47J 27/10; A47J 36/32

(57) ABSTRACT

Cooking methods and devices for controlling doneness gradients and/or processes using modulated cooking techniques. A precision cooking appliance is provided that allows for cooking food to a precise internal temperature as well as keeping the food both before and after cooking at desired holding temperatures. One or more temperatures sensors are placed adjacent, near, and/or in the food to be cooked so that the temperature of at least one cooking surface can be controlled to reach the precise internal temperature. Related apparatus, systems, techniques and articles are also desribed.

### TECHNICAL FIELD

The subject matter described herein relates to the culinary arts, and in particular, to precision cooking appliances and methods of using the same.

### BACKGROUND OF THE INVENTION

Home-based cooking technologies have advanced over the last decade to utilize less well-known techniques such as sous vide cooking. There are typically four kinds of sous vide devices on the market, though these are not the exhaustive way of cooking sous vide. immersion (circulators), water baths, all-in-one sous vide machines, and steam ovens (including CVAP) Immersion heaters are usually vertical towers meant to be inserted into a cooking container filled with water. The top of the tower sits above the liquid and contains the controls, display, and. Inside the tower, below the liquid level, is the heating element, a temperature sensor, and, if a circulator, either a fan or pump to circulate the fluid for even temperature distribution. Water bath, aka, Bain-Marie, cooking existed for decades before Sous Vide. Bain Marks do not have precision control, so they cannot be used for low temperature cooking. Steam ovens are extremely expensive. These are used primarily by professional kitchens and so will not be discussed further.

Because the food to be cooked in water has to be placed in the water, the food is protected by being placed in a plastic cooking bag which is vacuum sealed to eliminate air pockets that would act to insulate the food from the cooking water. Cooking in plastic is problematic. Many consumers are concerned about possible health implications of having the cooked food in close contact with plastic bags, as well as the environmental implications of non-reusable bags.

While these technologies work for low-temperature cooking, they have their disadvantages for use by the average home consumer. They take up a lot of room, and the cooking water is slow to hear or cool and without a circulator, tends to develop hot and cold spots. Neither technology can chill the food quickly after cooking.

In addition to sous vide, traditional cooking can be used that includes a heat source that is at a temperature either: 1) somewhat above the ideal cooking temperature for a food (e.g. crockpots, braising) or 2) far above the desired final internal temperature (e.g. roasting, grilling, frying). In the former case, texture suffers. In the latter, timing is critical and even small errors result in over- or under-cooked food.

Another cooking technique is sometimes referred to as target temperature cooking, which is geared towards reaching, but not exceeding, a desired internal temperature of the food (referred to herein as Target Temperature (TT)). Sous vide is a type of target temperature cooking.

### SUMMARY

One aspect of the invention relates to methods and systems for cooking using modulation to control and/or modify the cooking results.

Another aspect of the invention relates to methods of achieving “best effort” cooking within specified time limits and/or other limitations.

Another aspect of the invention relates to methods and cooking systems comprising skirts or barriers to reduce or eliminate the loss of temperature within the cooking device caused by radiation and/or air flow.

Another aspect of the invention relates to precision cooking appliances that allow for cooking food to a precise internal temperature as well as keeping the food both before and after cooking at desirable holding temperatures.

Another aspect of the invention relates to computer-implemented methods, algorithms and systems using computer-implemented algorithms configured to perform the methods described herein.

The foregoing has outlined some of the aspects of the present invention. These objects should be construed as being merely illustrative of some of the more prominent features and applications of the invention. Many other beneficial results can be obtained by modifying the embodiments within the scope of the invention. Accordingly other objects and a full understanding of the invention may be had by referring to this summary of the invention, the detailed description describing the preferred embodiment in addition to the scope of the invention defined by the claims taken in conjunction with the accompanying drawings. The unique features characteristic of this invention and operation will be understood more easily with the description and drawings. It is to be understood that the drawings are for illustration and description but do not define the limits of the invention.

### DESCRIPTION OF DRAWINGS

The accompanying drawings, which are included as part of the present specification, illustrate the presently preferred embodiment and, together with the general description given above and the detailed description of the preferred embodiment given below, serve to explain and teach the principles of the present invention.

FIG. 1 is a graphical representation of a cooking method according to one embodiment of the invention showing a vertical axis representing temperature (° F.) and the horizontal axis representing time.

FIG. 2 is a graphical representation of a cooking method according to another embodiment of the invention showing a vertical axis representing temperature (° F.) and the horizontal axis representing time.

FIG. 3 is a graphical representation of a cooking method according to another embodiment of the invention showing a vertical axis representing temperature (° F.) and the horizontal axis representing time.

FIG. 4 is a graphical representation of a cooking method according to another embodiment of the invention showing a vertical axis representing temperature (° F.) and the horizontal axis representing time.

FIG. 5a is a diagram illustrating a precision cooking appliance;

FIG. 5b is a diagram illustrating cooking surfaces of the precision cooking appliance of FIG. 5a;

FIG. 5c is a diagram illustrating food between the cooking surfaces of the precision cooking appliance of FIG. 5a;

FIG. 6 is a diagram illustrating a controller for the precision cooking appliance of FIG. 5a;

FIG. 7 is a diagram illustrating heating elements on at least one cooking surface of the precision cooking appliance of FIG. 5a; and

FIG. 8 is a logic diagram illustrating various components of the precision cooking appliance of FIG. 5a.

FIG. 9 is a drawing of a contact grill (with the handle removed for clarity) with a skirt around the open sides according to one embodiment of the invention.

FIGS. 10A-10D are graphical representations of touch-screen gestures.

### DETAILED DESCRIPTION

The above mentioned and other features of the inventions disclosed herein are described below with reference to the drawings of the preferred embodiments. While the present description sets forth specific details of various embodiments, it will be noted that the description is illustrative only and should not be construed in any way as limiting.

Definitions:

Contact Grill: A cooking appliance that heats two surfaces of the food simultaneously. A typical contact grill will cook both the top and bottom sides of food at the same time, typically by having two heated surfaces that make direct contact with the food. Alternately, one or both of the surfaces could be replaced by radiant heat sources, in which case the infra-red heat waves make direct contact with the surface of the food.

Cooking Completion Time (CCT): The time the user (e.g., cook) wishes to serve and/or is allotted to cook the food. This can be communicated by the user to the device and by the device to the user in two ways, either as a set number of hours from the present or as a specific day/date and time. The initial CCT will be equal to the minimum best time (MBT), but may be increased or decreased by the cook using “Best Effort” cooking, as described in the “Best Effort” section of this document.

Cooking Contour: The temporal sequence of heat or energy applied to the food over the course of cooking.

Doneness: The condition of the internal temperature of a food being raised to the desired degree. For example, some commonly-used terms for doneness are Rare, Medium, and Well. A food can achieve the proper level of “Doneness” without being ready-to-serve, e.g., while a medium-rare New York steak may be ready to serve the moment it has achieved an internal temperature of 130° F., a chuck roast may require a full 24 hours of additional cooking to achieve tenderness (see below) after it has reached its internal target temperature (TT) of 160° F.

Doneness Gradient: The pattern of “doneness” of the cooked food as a function of location between a first side and an opposing side of the food being cooked. Usually (but not necessarily), the gradient is symmetrical around the center of the food, with the outer layers having the maximum degree of “doneness” and the center of the food being at the target doneness. With a typical “V-Shape” or “Bull's Eye” doneness gradient, the outer layers are more highly cooked than the center. However, with a “flat” doneness gradient, the food is at the same degree of doneness at all depths

Holding Temperature: After the food has completed its desired cooking, it is kept at a holding temperature (THold) that is typically at or below the target temperature of the food.

Low Temperature Cooking: Precision cooking in the range of 100° F. to 190° F. This range is below that of traditional slow cookers (crock pots) and is currently used only by sous vide devices.

MBT or Minimum Best Time: The ideal time to cook a given food to the cook's desired degree of doneness (see above) and level of tenderness (see below).

Multi-Side Heating Appliance: A cooking appliance that includes two or more heated plates or radiators.

Safe Temperature: The temperature above which pathogens will not form and the foodstuff can be held at this temperature indefinitely without increased risk of causing sickness in the eater.

Source or “S”: Heat or energy source (e.g., resistive heating coil, inductive source, flame, radiant (infra-red) heat, microwave, etc.).

Searing: Searing is the application of high temperature (usually>300° F.) to the outside of the food. Searing enhances the aesthetic appearance of the cooked food, making it close to what has been culturally accepted. More importantly, searing produces a Maillard, nonenzymatic reaction, between the sugars and proteins of the surface, browning the surface and releasing attractive odors and flavors.

Source Temperature: TS: Temperature of the cooking source.

Substantially: The term “substantially” (or “substantial”) means that ninety-five percent of the values of a physical property when measured along an axis of, or within a plane of or within a volume of the structure, as the case may be, will be within plus or minus five (5) percent of an average value. For example, “substantially the same amount of doneness throughout a food” means the food is cooked uniformly throughout with any variation of doneness being less than 5% from the average doneness.

Target Doneness (or “TD”): The doneness level of food when at TT.

Target Temperature (or “TT”): Target temperature of the food. For proteins, e.g. meat, fish, and eggs, usually a desired TT is specified particular to the desired end result of the food: the “doneness” level (See “Doneness,” above). For example, some sources recommend that medium rare beef have a TT of 130 to 135° F. TT is selected so that when food is at TT is has also reached the target doneness level of cooking.

Target Hold (or “Thold”): The holding temperature (see definition above).

Tenderness: The ease of cutting and/or chewing of a food. Tenderness is separate and distinct from doneness (see above). For example, while a fine steak, such as a New York or Filet Mignon, may reach ideal tenderness simultaneous with achieving ideal doneness, tougher protein cuts such as a chuck steak may require as much as a day of further cooking after achieving the desired temperature for doneness in order to reach the desired tenderness. The same is true of many other foods including vegetables.

One aspect of the invention relates to methods and systems for cooking using modulation to control and/or modify the cooking results.

In traditional cooking, a heat source (S) of Temperature TS is situated near or contacting the food, generating a surface temperature equal to or greater than the desired target temperature (TT) of the food. The food is then removed when the center has reached, or just before it has reached, the target temperature. Usually TS is considerably greater than TT.

If the temperature of the heat source (TS) is greater than TT (TS>TD), the interior of the food has a gradient of “doneness” with the center at the target cooking doneness (TD) and with the food being progressively more and more cooked toward the periphery, sometimes termed the “V-Shape” or “bull's eye” effect.

When TS=TT, the result is uniformly cooked food wherein the food is equally done throughout as opposed to traditional cooking which results in the bull's eye effect. This outcome is referred to herein as “flat gradient cooking.” A conventional method of achieving flat gradient results is through use of a precision-controlled water bath (Sous Vide cooking).

Flat gradient cooking has both disadvantages and advantages. One well-known disadvantage is the lack of searing of the food surface. Searing enhances the aesthetic appearance of the cooked food. More importantly, searing produces the Maillard, nonenzymatic reaction between the sugars and proteins of the surface, browning the surface and creating attractive odors and flavors. This deficiency is well-known and is usually overcome by the cook applying intense heat at the start or end of the cooking in a separate cooking device.

A second disadvantage is cooking time: when the heat source is at TT, this is a relatively low temperature differential to the food temperature, so to get the entire food to TT can take times measured in hours.

The present invention relates to methods for controlling the internal temperature and temperature gradient of food by means of various combinations of device design features which modulate the energy or heat source to achieve a desired cooking profile inside, and outside the food.

The invention may fulfill one or both of the following goals:

Goal One: Maintain precise application of heat to the food being cooked to achieve the desired temperature profile throughout the food.

Goal Two: Alter the desired temperature from time to time to match the Cooking Contour. A preferred sequence might include elements such as a high temperature pre-sear, followed by a period at a holding temperature, followed by a final sear just before serving time, or might vary the temperature smoothly.

In one embodiment of the invention called pulsed heating, a rapid modulation is used applying energy to the food sufficient to raise the surface of the food to a desired temperature, then decreases power applied for sufficient time to allow the surface heat to migrate into the food through conduction. The reduced power duration must be long enough to allow the surface temperature to cool to TT or less. At that point, the process repeats. This continues until the target location reaches TT. This method works with any heat source that allows for rapid modulation, which includes, at the extreme, rapid transition between completely on to completely off. Heating and energy sources appropriate to modulated cooking include microwave cooking devices, contact grills, induction cooking, and radiant heat sources, such as intense light sources.

In other embodiments of the invention, rapid modulation is not required.

Advantageously, if the food is to be seared, it is permissible to let the surface temperature rise above TT because the searing will overcook this area anyway. This higher surface temperature speeds up heat conduction to the inner parts of the food according to preferred embodiments of the invention.

According to preferred methods of the invention, the modulation is determined by the current temperature at the food's surface, the food's internal temperature at one or more points, mathematical models of heat transfer within the food, or some combination thereof and the desired doneness gradient, the modulation being controlled by a control unit supervising the heat source.

According to preferred methods of the invention, the resulting cooked food has a flat gradient of doneness such that the resulting cooked food has the same or substantially the same amount of doneness throughout.

According to preferred methods of the invention, the modulation is designed to produce any doneness gradient selected by a user (e.g., a cook).

According to preferred methods of the invention, the method further comprises receiving a selected doneness gradient request from a user and modulating the cooking based on the request to result in the selected cooking

According to preferred methods of the invention, the cooking is performed without the use of a containment means (e.g., bag, sealable container, etc.) necessary to exclude other liquids (e.g. the water used as a thermal transfer medium in today's Sous Vide methods) from contact with the food during cooking. It is, however, also possible to perform the cooking method with the use of a containment means (e.g., bag, sealable container, etc.) capable of containing liquids (e.g., sauces) around the food during cooking

According to preferred methods of the invention, the heat source is selected from the group consisting of microwave cooking source, induction cooking source and radiant heat source.

According to alternative most preferred methods of the invention, the heat source comprises a contact grill.

Another embodiment of the invention relates to a method of cooking a food with a heat source comprising controlling the temperature and temperature gradient of the food by modulating the heat source intensity during the cooking.

Yet another embodiment of the invention relates to a method of cooking a food to a desired doneness gradient using a heat source that is controlled to modulate the cooking wherein:

i. the source delivers energy to the food to increase the surface of the food to a desired temperature;

ii. the delivery of energy is paused or reduced for a sufficient time to allow surface energy to migrate into the food through conduction and allow the surface to cool to the target temperature or less; and

iii. (i) and (ii) are repeated until the center of the food has reached the target temperature.

According to one preferred embodiment, the cooking device is a contact grill. According to alternative preferred embodiments, the cooking device is an oven or single-sided grill/griddle. According to still further embodiment, the cooking device is another type of cooking appliance. Preferably the device determines the temperature or status of the cooking using a temperature probe, sensor, algorithm or combinations thereof.

According to another preferred embodiment, the methods further comprise searing the food by delivering higher energy to the food to increase the temperature at the surface sufficient to result in searing.

According to another preferred embodiment, the methods further comprise controlling the transmission of energy to the food so as to produce a range of desired doneness gradients, ranging from a flat doneness gradient to a graded gradient, with the outside surfaces cooked more than the center, resulting in a bulls eye or v-shaped doneness gradient, or any variant as desired by the cook.

According to preferred embodiments of the invention, the term modulation refers to active control of the heat or energy source with the ability to vary output smoothly from 0% to 100%.

The modulating adjustments vary widely depending on factors including the foodstuff, the size and/or weight of the food, the desired gradient and doneness, the time available, and the starting temperature of the food.

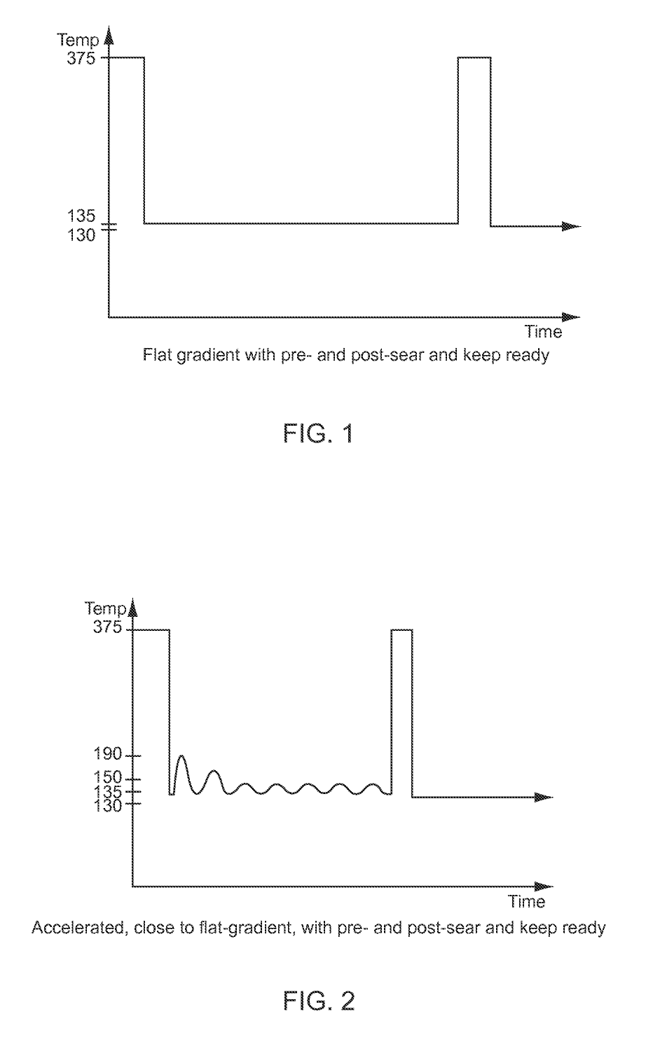

FIG. 1 is a graphical representation of a cooking method according to one embodiment of the invention where the vertical axis represents temperature (° F.) and the horizontal axis represents time. As shown in the graph, the cooking temperature (i) starts at 375° F. for a short period of time to result in a pre-sear, (ii) drops to 135° F. for a longer period of time to provide a flat gradient cooking profile, (iii) increases again to 375° F. for another short period to provide a post-sear and finally (iv) drops to 130° F. to keep the food at a holding temperature until ready for consumption (herein “keep ready period”).

FIG. 2 is a graphical representation of a cooking method also including a pre- and post-sear step, but also including there between several smaller modulations ranging between 130 and 190° F. to provide an accelerated flat-gradient cooking profile followed by a “keep ready” period.

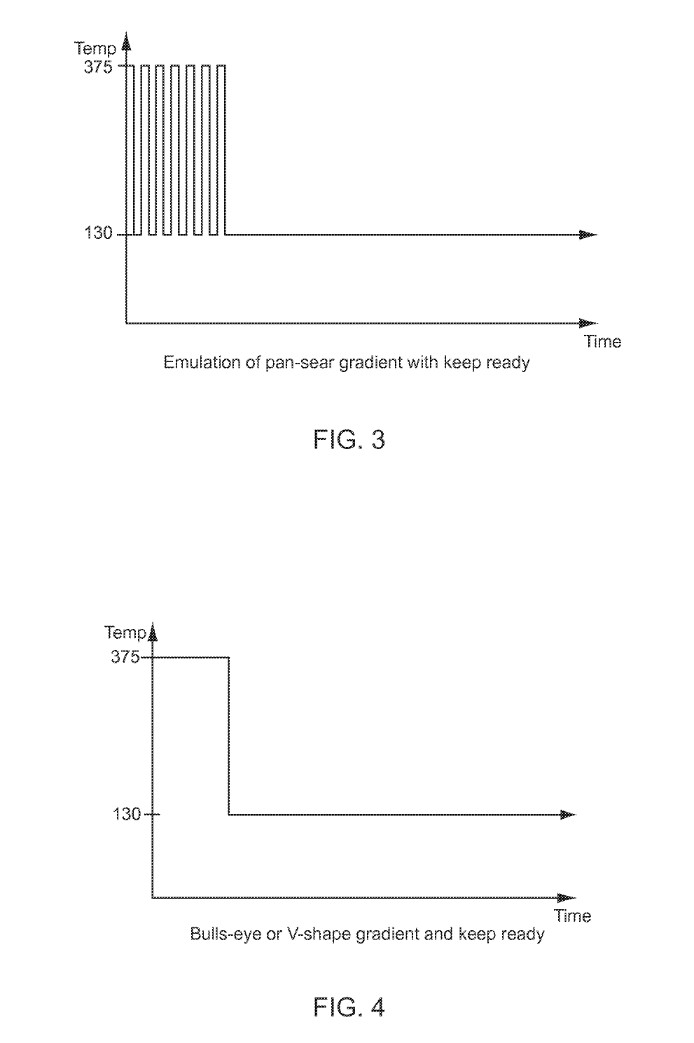

FIG. 3 is a graphical representation of a cooking method according to another embodiment of the invention emulating a pan-sear gradient (the flip method) followed by a “keep ready” period. As can be see, the emulation of a pan-sear uses larger range temperature modulations between 130 to 375° F. within shorter time periods.

FIG. 4 is a graphical representation of a cooking method according to another embodiment of the invention emulating a Bulls-eye or V-shape gradient followed by a “keep ready” period.

Another aspect of the invention relates to methods of achieving “best effort” cooking within specified time limits and/or other limitations.

Because flat-gradient cooking is usually performed using a water-bath method, neither chefs nor scientists could alter the cooking temperature rapidly except by moving the food to a different device (this is often done for the final searing, when the food is removed from the water bath, dried, and then seared on a grill or with a blow torch).

The “precision cooking device” described below allows for rapid temperature change, removing the one-temperature limitation of most cooking devices. The present invention provides a method of applying that capability of a precision cooking device in order to shift the temperature of the plates continuously over the life-cycle of the cooking process based on the pre-determined cooking contour of the food being cooked and/or in response to internal and external temperature readings of the food.

According to preferred embodiments of this invention, the cooking temperature is modulated in a continuous manner so as to achieve the cook's desired doneness gradient within the time period provided. For many cooks, the desired doneness gradient is for a flat gradient, but for many others, the desire might be for a V-shaped or bull's eye gradient, or somewhere in between. According to preferred embodiments of the invention, a cooking device controller and its algorithm supports this decision or selection by the cook. Given the taste preferences and constraints coupled with the desired doneness gradient, the device and method of the invention attempts a “best effort” to fit or achieve the desired result.

For example, should a cook desire a Cooking Completion Time (CCT) that is longer than the Minimum Best Time MBT (see definitions), the device will extend the MBT by altering the cooking contour (see definitions) through a variety of methods. For example, the system might lower the temperature of the cooking source (TS) and resulting internal temperature of the food until shortly before Cooking Completion Time, then raise TS so the food achieves the cook's target doneness (TD) at Cooking Completion Time. Alternatively, the system, if it “knows” the cook will sear at the end, the system might use the extra time to cool the food off. During the subsequent sear, because the internal temperature of the food has dropped below the target doneness, the heat from the sear will not raise the interior above the target doneness, further minimizing the bull's eye effect.

Should the cook fail to remove the food at the minimum best time or the cook's indicated Cooking Completion Time, the device will take steps to lower the temperature of the food either passively or actively (e.g., using fans, thermoelectric cooling, etc.). The device will then preferably stabilize the food at a lower holding temperature until such time as the cook chooses to remove the food.

The above-described examples as referred to herein as “best effort” cooking: the system of the invention selects the best possible sequence of cooking temperatures (contour) so as to maximize the resulting food quality, even if the time allowed is greater or less than ideal time. When perfect flat gradient cooking is not possible, the system does a “best effort” approximation to flat gradient.

The goal is to achieve as close to user Taste Preferences as possible, always ensuring that the center of the food never exceeds target temperature (TT) with the surrounding area as close to TT as possible even when the desired cooking time is less than that which would be required to achieve perfect flat gradient cooking.

According to preferred embodiments, the cooking is modulated to result in a best effort cooking within the time period desired.

For example, if the time provided for cooking is too short, it is simply not possible to get a flat gradient or even a V-Shaped or Bull's-eye doneness gradient. According to the invention, the methods achieve the “best effort” toward that end by, for example, overcooking the center of the food as little as possible to get a food which requires a specific amount of time at temperature to achieve an acceptable level of tenderness cooked in the desired amount of time. That is, if no cooking contour can get to the requested gradient, the cooking contour is modulated or otherwise adjusted to get as close as is possible given the time requested.

Preferably, a cross-section of a food cooked using a “best efforts” would not be readily distinguishable from the traditionally made food cooked for the traditional time to result in the exact doneness gradient.

According to another preferred embodiment, the time period selected is longer than necessary for the food to achieve the requested doneness gradient and the method comprises lowering the temperature of the energy source and resulting internal temperature of the food after the food has reached the target doneness and gradient and holding the temperature until the time period is finished.

According to another preferred embodiment, the method further comprises searing the food by cooling the food to an internal temperature below the target doneness and thereafter increasing the heating source to allow for searing of the surface of the food without overheating the inside of the food.

Overheating refers to increasing the temperature of a part of a food past the requested level of doneness (which can vary with the requested gradient, as well) such that it will be noticeable to the consumer. The threshold for noticing overheating can vary from 1° F. to more than 20° F. depending on the food, requested gradient, target doneness, and sophistication of the consumer.

According to another preferred embodiment, the method comprises overheating the surface during the time the food's internal temperature is below target temperature to boost the heat conduction in the early cooking stages.

Another embodiment of the invention relates to a method of controlling the cooking of the food in a device using a modulated heat source to achieve the optimum doneness gradient of doneness and/or tenderness given the time specified using an algorithm utilizing one or more of the following parameters: (i) type of food; (ii) food toughness; (iii) thickness and/or shape of food; (iv) moisture level of the food; (v) fat content of the food; (vi) any other physical property of the food; (vii) requested doneness of the food; (viii) requested tenderness of the food; (ix) time available for cooking; (x) starting temperature of the food; (xi) whether searing will to be done, and if so, whether at the start or end or both start and end of the cooking cycle; (xii) requested cooking duration; and (xiii) pre-determined cooking contour.

According to preferred embodiments, the control unit determines a cooking contour using a database of foods (e.g., preferably the database includes their cooking times, temperatures, etc.). Preferably, the database is stored off the device. According to an alternative embodiment, the database is stored in the device. According to a still further embodiment, one or more databases is stored on the device and one or more off the device or remote from the device.

According to one preferred embodiment, the algorithm determines a cooking contour using a database of food, e.g., preferably including the food's cooking times, temperatures, etc.

According to another preferred embodiment, the algorithm determines a cooking contour based on a user's manual entry of cooking time, doneness gradient and food.

According to another preferred embodiment, the method further comprises a display for the interface.

According to another preferred embodiment, the method further comprises controls and a display for the interface that are located remotely from the cooking appliance, connected by wires, infra-red, or by a wireless (radio) connection.

As used herein, user preferences can refer to the taste, texture, look, smell, doneness (e.g., definitions of “medium-rare” may vary between users, and people who like one cut at one doneness generally want all cuts made to that same doneness), general food preferences, etc.

According to another preferred embodiment of the cooking appliance, the one or more sensors are incorporated into the controller and the one or more sensors measure parameters selected from the group consisting of:

(a) coil currents for resistive and/or inductive heating elements;

(b) cooking plate temperatures;

(c) food temperature at various locations along the food and/or within at various depths (such as surface and center temperatures);

(d) thickness of the food;

(e) food weight detector;

(f) steam detector; and/or

(g) smoke detector.

Another aspect of the invention relates to a computer based system configured for performing any of the methods of the invention described herein.

One embodiment relates to a computer based system comprising at least one computer device comprising at least one processor coupled to the memory, and also coupled to the one or more sensors, the memory having computer readable code, which when executed by the processor causes the computer based system to perform the methods described herein.

Another embodiment relates to a non-transitory computer readable medium including instructions that, when executed by a processing device, cause a cooking appliance to perform any of the methods described herein.

According to preferred embodiments of the invention, a controller with special-purpose human interface and cooking algorithm controller is used to determine the appropriate cooking contour, given a specified food, the desired cooking style, and cook's requested Cooking Completion Time (see definitions).

Preferably, the cooking controller and its algorithm considers multiple parameters to determine the cooking sequence. For example, the algorithm might consider (but is not limited to):
Type of food (e.g., Salmon, trout, beef, chicken)
Food toughness (e.g., USDA rating)
Thickness and shape of food
Time available for cooking, i.e.,Time-avail.
Starting temperature of the food, including whether frozen or not.
Whether searing is to be done, and if so, whether at the start or end of the cooking cycle
The cook's requested cooking time duration
A pre-determined “cooking contour” for either the specific food being cooked, e. g., salmon, or, where that is not available, the class of food being cooked, e. g, fish.
Any other relevant parameters

Preferably, the device determines a cooking contour using a database of cooking times either stored internally and/or available through a computer, internet, intranet or related means. Preferably, a display is mounted on the device and/or a controller and display connected via some form of wired or wireless connection. This provides such information as food doneness gradients, tables/rules for various foods that dictate initial temperatures, heating and cooling variations during the course of cooking, and final temperatures, including the impact of pre- and post-cook searing. The controller and its algorithm can then determine a cooking contour that cooks the food for the desired time with results as close as possible to the result that would occur with flat-gradient cooking or any other gradient preferred by the cook.

For example, a particular food item takes Time-trad minutes to cook using traditional cooking methods and Time-flat minutes to cook to a flat gradient using Target Temperature cooking Furthermore, the time available for cooking is Time-Avail. According to preferred embodiments of the invention, the cooking device, the method of cooking and the resulting doneness gradient of the food is determined by the amount of time available for cooking, Time-avail.

According to preferred embodiments, the resulting cooking temperature schedule would be as set forth in Table A below:

TABLE A

| Available time | Cooking | |
|---|---|---|
| (Time-avail) | temperatures | Comments |
| Less than Time-trad | Cooking | The device signals that this time is not |
| | temperature | possible without significantly affecting the |
| | selected to produce | result. The cook is prompted as to whether |
| | best compromise | they want to use the short time they've |
| | food in Time-avail. | chosen anyway. If so, temperature is |
| | | increased as needed. If not, device would |
| | | increase Time-avail to equal Time-trad. |
| Equal to Time-trad | Cooking | The food is cooked conventionally |
| | temperature | |
| | selected to produce | |
| | traditionally cooked | |
| | food in Time-avail. | |
| Between Time-trad | Cooking | This is a “Best Effort” range where the |
| and Time-flat | temperature contour | cooking contours produce “Best Effort” |
| | selected so that | results as close to flat gradient as possible |
| | internal temperature | given the time constraint. |
| | of food reaches TT | |
| | at Time-avail. | |
| Equal to Time-flat | Food is cooked at | This is the ideal case for flat gradient |
| | target temperature | cooking. Note that time can be reduced |
| | | over traditional flat-gradient cooking if the |
| | | food is to be seared (see section “Speeding |
| | | of Cooking Time When Food Is to be |
| | | Seared.” |
| Greater than Time- | Cooking | This is a “Best Effort” range where the |
| flat | temperature contour | cooking contours produce “Best Effort” |
| | selected so that | results achieving as close to ideal |
| | internal temperature | tenderness (see definitions) as possible. |
| | of food is lowered | |
| | sufficiently to | |
| | prevent | |
| | overcooking, with | |
| | the contour | |
| | ensuring the food is | |
| | at the best possible | |
| | temperature at | |
| | Time-avail for | |
| | either searing or | |
| | serving. | |

According to preferred embodiments, the cooking may be terminated prior to the internal temperature reaching TT if the cooking algorithm determines that internal temperature will continue to rise after the cessation of external heat source. This prevents overcooking of the food as known in conventional cooking.

In one embodiment, at the end of the cooking period, TS is reduced to a holding temperature (THold) and the cook preferably informed (e.g., a noise, light or other indication). The THold temperature is selected to minimize further cooking while maintaining the food at a safe holding temperature.

According to another embodiment, the methods comprise a speeding of cooking time when the food is to be seared.

Preferably, the algorithm provides for shortening of cooking times when food is to be seared (whether at the start or end of the cooking cycle) because there is no need to take care that the outside layer not exceed the target temperature. This permits the temporary application of an above-target temperature to the outside of the food, thereby reducing total cooking time. This extra temperature, when applied while the interior of the food is below target temperature, will primarily impact the sear layer, so it does not detract from the goal of optimizing uniformity in final degree of “doneness” for the major portion of the food.

According to preferred embodiments, a controller interface is provided. Preferably, the human interface for control of the cooking consists of an input mechanism, one or more display elements (both visual and auditory), and controls for starting, stopping, pausing, and otherwise changing the operation of the device.

Preferably, the input mechanism provides for entering the information required by “the algorithm” (see description above). This information may be manually entered, some read from the food label by any one of several means including optical or character recognition of food labels, optical or radio collection of information on bar codes or RFID labels, pre-stored menus or menus available on the internet.

According to preferred embodiments, the cooking system or appliance may be configured to allow other inputs to be entered on keyboards, menus, or other selection devices, either implemented in dedicated hardware or through touch- or gesture-controlled sensing mechanisms.

Preferably, the controller is located on the device, external to the device on a separate controller or electronic controller (which could include software residing on a standard commercial cellphone, tablet, or computer). The controller could be distributed with some or all of the controls on the device and/or some or all on an external device, with redundant controls on the various devices a possibility.

Preferably, the display will graphically depict the state of the device, possibly including the parameters selected (desired doneness, food type, gradient selected, cooking contour, current temperature of the energy source and of the food, time remaining, etc).

Another aspect of the invention relates to methods or cooking systems comprising skirts or barriers to reduce or eliminate the loss of temperature within the cooking device caused by radiation and/or air flow.

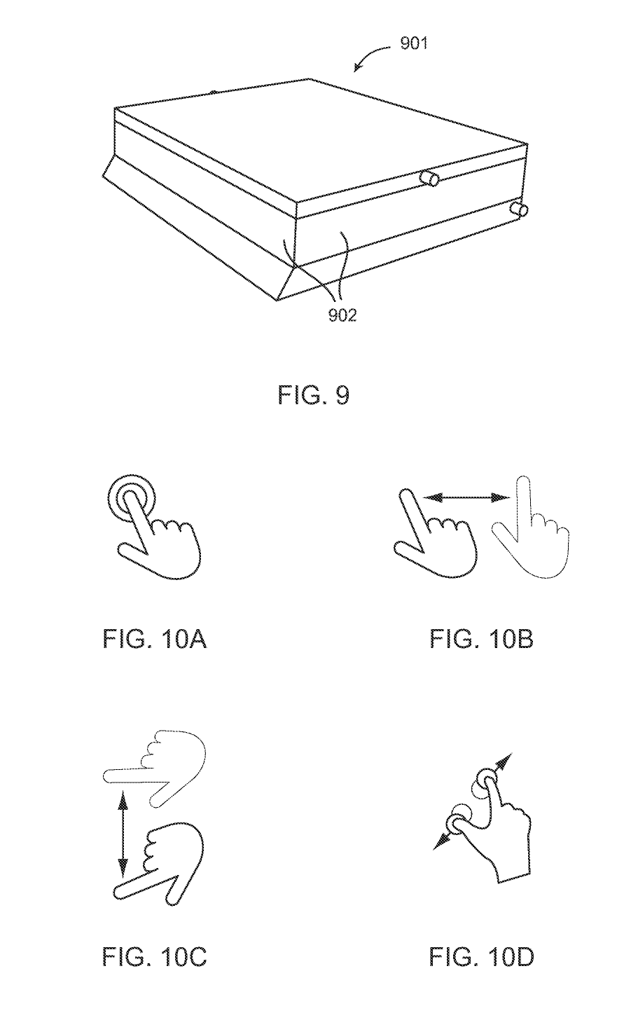

According to traditional methods, if one cooks with a heat source on the top and bottom of the food, the sides are exposed and thus cooler than the heated sides. This can cause the sides and any portion of the top or bottom not making direct contact with the food to drop them below TT and not achieve the doneness profile at those points. FIG. 9 shows a contact grill 901 (with the handle removed for clarity) with a skirt 902 around the open sides according to one embodiment of the invention.

This aspect of the invention combines the safety, energy-efficiency, and flexibility of an enclosed vessel with the advantages of a contact grill. Providing a closed or substantially closed environment cuts off that ambient air while also offering the potential for greater flexibility in recipes, enabling the home cook, for the first time, to apply low-temperature cooking methods to foods with wet ingredients, such as soups and stews.

One embodiment relates to a cooking device having an environment for the cooker providing heating, insulating, or similar, materials completely surrounding the foodstuff to prevent cold or ambient air significantly below the target temperature or cooking temperature from hindering the cooking process.

Preferably, parts of the containment vessel might be of materials such as steel, aluminum, leather, plastic, or other thermal buffers. Even a jet of air might be used to create an airflow barrier. Regardless of the material or method, the surround will prevent air from flowing through and drafting away heating energy from the foodstuff. It may or may not contain a volume of liquid or moisture from the foodstuff, or isolate moisture from the air. It may or may not create a hermetically sealed environment where pressure could be regulated, and/or an environment where moisture could be regulated. Preferably, heating elements will transfer heat directly into parts of the containment vessel in order to cook the food.

Another embodiment (“Embodiment One”) of the invention relates to a system comprising a permanent rectangular or oval-shaped vessel with, on the bottom, a flat-plate heat source and, on top, either a vertically adjustable flat-plate heat source, a fixed-height radiant heat source, or a vertically-adjustable radiant heat source. The radiant heat source preferably extends down the sides of the vessel. The system preferably also comprises a drain and a second vessel to catch the drained fluid. The cook places the food in the vessel, lowers the hinged top and, if necessary, further lowers a top plate into place. The cook then sets the cooking parameters, and the food is cooked. The precision-controlled cooking environment according to the invention extends the current capability of “Slow Cookers” that specialize in wet cooking down into the much lower temperature sous-vide range, improving the final product.

The following embodiments relate to devices that more closely resemble a traditional contact grill, featuring a removable side wall to allow conventional cooking when it is removed. One preferred embodiment relates to a device comprising a contact grill-based embodiment that would incorporate a flexible and removable side wall that might or might not be watertight at its base. The cook would place the food in the cooker, then lower the top plate until it contacts the food, with the side walls telescoping, bowing, folding, or otherwise adjusting to accommodate the required height.

Another preferred embodiment relates to a cooking device configured to supply the cook with a graduated series of rigid sidewalls, with the cook choosing the most appropriate one.

Yet another embodiment relates to a cooking device configured to supply the cook with two bottom plates: A snap out bottom plate that resembles that on a traditional electric contact grill and a second plate the user could replace it with that would be a cooking vessel similar to the embodiment described above. Cooking would then proceed as with Embodiment One described above.

Another embodiment of the invention relates to a cooking appliance for cooking food comprising a cooking chamber capable of being sealed during cooking to prevent a temperature drop at the open sides of the food due to radiation and/or airflow.

As used here, “open sides” refers to sides of food not directly contacted by heating elements nor receiving sufficient radiation heating to keep the surface at the desired cooking temperature.

According to another preferred embodiment, the appliance further comprises heating elements configured to transfer heat directly into the cooking chamber in order to cook the food.

According to another preferred embodiment, the appliance further comprises adjustable heating surfaces which can be pre-heated and subsequently moved into contact with the food.

According to another preferred embodiment, the appliance further comprises heating elements configured to directly heat the food through conduction.

According to another preferred embodiment, the cooking chamber further comprises a hinged top.

According to another preferred embodiment, the cooking chamber further comprises a front door to load and remove food.

According to another preferred embodiment, the cooking chamber further comprises two or more heating elements to heat one or more direct heating side(s) of the food and a heating source for the sides, which may be radiant heat, and may be part of a skirt prevent loss of heat through radiation and/or air flow.

According to another preferred embodiment, the cooking chamber comprises adjustable walls capable of being adjusted to contact the food.

According to another preferred embodiment, the adjustable walls are removable.

According to another preferred embodiment, the adjustable walls allow liquid to pass.

Preferably, the plate(s) are shaped for one or more specific foods or food types. Preferably, the bottom plate(s) form a vessel capable of holding a liquid.

Preferably, one or more temperature sensors are placed adjacent, near, and/or in the food to be cooked so that the temperature of at least one cooking surface can be controlled to reach the precise internal temperature.

One preferred embodiment uses a contact grill, preferably a grill/griddle with a top and bottom plate, each plate controlled by a controller so that the food would cook to a uniform, flat gradient. Before and after the cooking cycle, the food temperature is preferably reduced to the holding temperature. According to preferred embodiments, the food is maintained at a safe temperature to prevent the growth of pathogens and/or bacteria.

According to one preferred embodiment, the appliance further comprises a controller configured to interact with and/or control (i) two or more heating elements; (ii) one or more cooling elements; and/or (iii) the one or more temperature sensors.

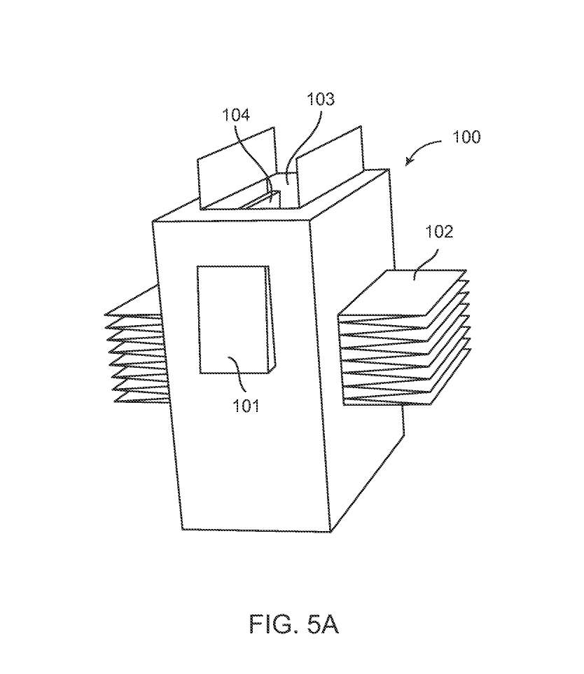

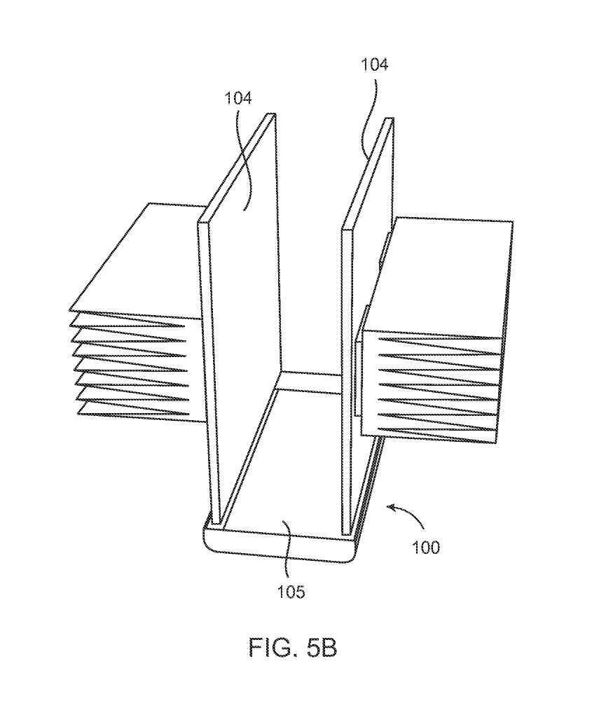

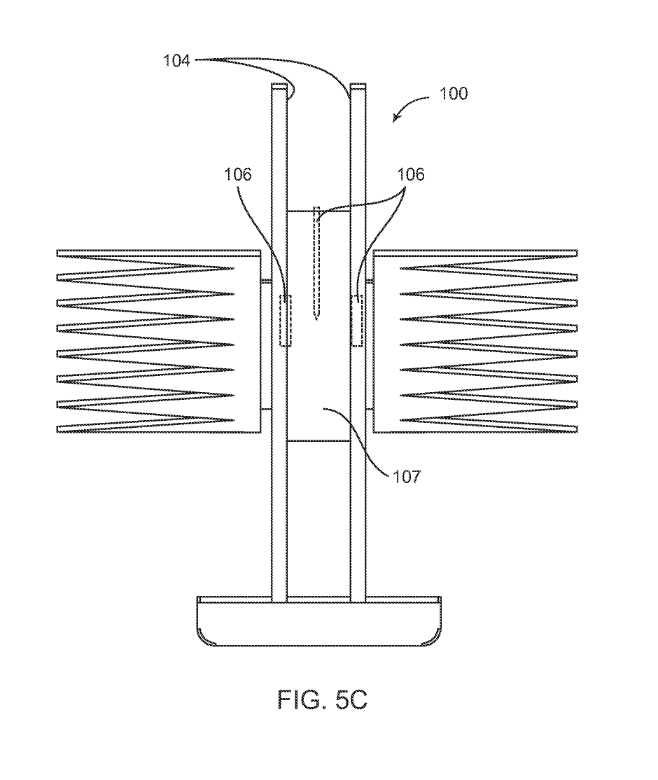

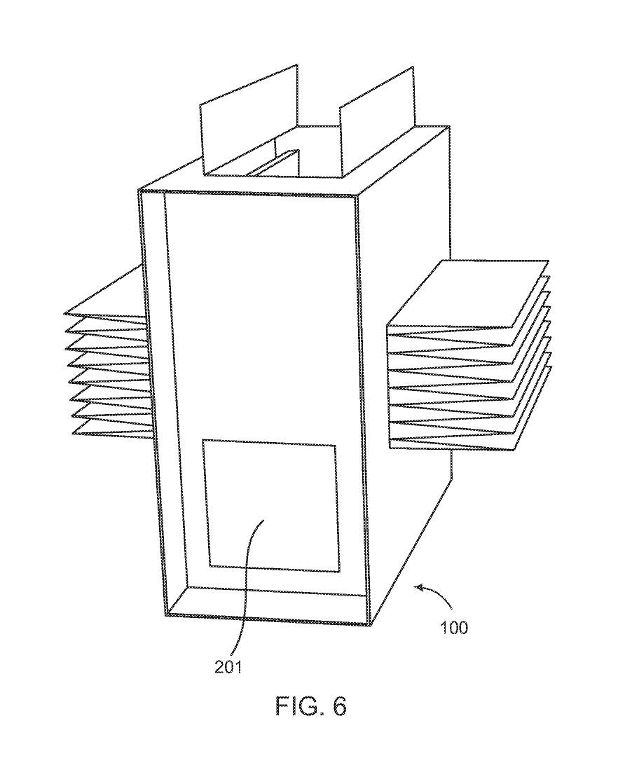

FIGS. 5-7 provide varying views of a precision cooking appliance 100 that can be used in a wide variety of settings including residential and commercial kitchens. As will be explained further below, the appliance 100 comprises at least one interface 101 by which a user can modify operational settings of the appliance 100 and/or monitor status of a cooking process (and/or receive guidance regarding same). Also included are at least two opposing cooking surfaces 104 that can be in any of a variety of shapes, textures, thicknesses (and between which food 107 is placed), at least one heat sink 102 for heat transfer purposes, and one or more temperature sensors 106. In addition, a tray 105 can be provided that is removable for cleaning and/or for catching drippings. A controller unit 201 can interact with and/or control one or more heating/cooling elements 301 as well as other sensors in connection with a cooking process.

The appliance 100 can incorporate both heating and cooling elements (which can form part of the same unit (as illustrated at 301 in) with, e.g., thermoelectric modules, etc.) with the controller 201 and one or more temperature sensors 106. The temperature sensors 106 can be placed at one or more locations where an accurate temperature reading can be obtained such as, for example, at the inner portion of the cooking surfaces 104, inside the food (via, for example, a wired probe, a wireless probe, or a probe extending from at least one of the cooking surfaces 104), and inside one or more of the cooking surfaces 104. Such a combination can provide the ability to: 1) keep the food 107 cold at THold until beginning of the cooking process; 2) cook the food 107 at exactly the desired TT (note that for some foods, TT changes during the cooking process (especially important for proper cooking of eggs and custards)); and 3) rapidly bring cooked food 107 to a chosen hot or cold THold for later consumption (which may be different than the initial THold temperature).

The cooking surfaces 104 can be rigid, malleable, compressible, flexible, segmented, removable, on adjustable (automatic or manual) mounts, or some combination of those. For example, the cooking surfaces 104 can be deformable so that they envelop the food. Such options can allow for better contact and/or easier cleaning.

In some implementations, the cooking surfaces 104 can be used in connection with an intermediate heat conductor to ensure more efficient heat transfer and/or more uniform heat transfer. In some cases, a liquid or gel having a thermal conductivity at least as high as the food 107 and that also does not impact the taste of the food 107 can be placed intermediate the cooking surfaces 104 and the food.

In addition, the cooking chamber defined by the cooking surfaces 104 can be oriented vertically (as illustrated) or at any angle down to horizontal. A removable tray to catch drippings from the food (105) can also be included.

Various types of heating devices can be used to transfer heat from the cooking surfaces 104 to the food 107. For example, thermoelectric modules (301—sometimes called Peltier devices), can be located within an internal part of the appliance 100 housing that are thermally connected to the cooking surfaces 104. With such an arrangement, a heat sink 102 or other thermal transfer agent can be used to transfer thermal energy from the external environment. Resistance heating can additionally be employed which can involve attaching a heating coil to the cooking surfaces 104 and/or embedding a coil in the cooking surface 104. Other types of heating techniques can be employed, including, but not limited to: compressors (e.g. vapor compression cycle); inductive heating of the food-contact surface; heat pumps; and heated fluid, either piped through the cooking surface or sprayed onto it.

In addition to precision heating, the appliance 100 can utilize cooling elements to selectively cool the cooking surfaces 104, and in turn, the food 107. For example, thermoelectric modules (301) can be used as well as compressors, heat pumps, chilled fluid conduits, and the like.

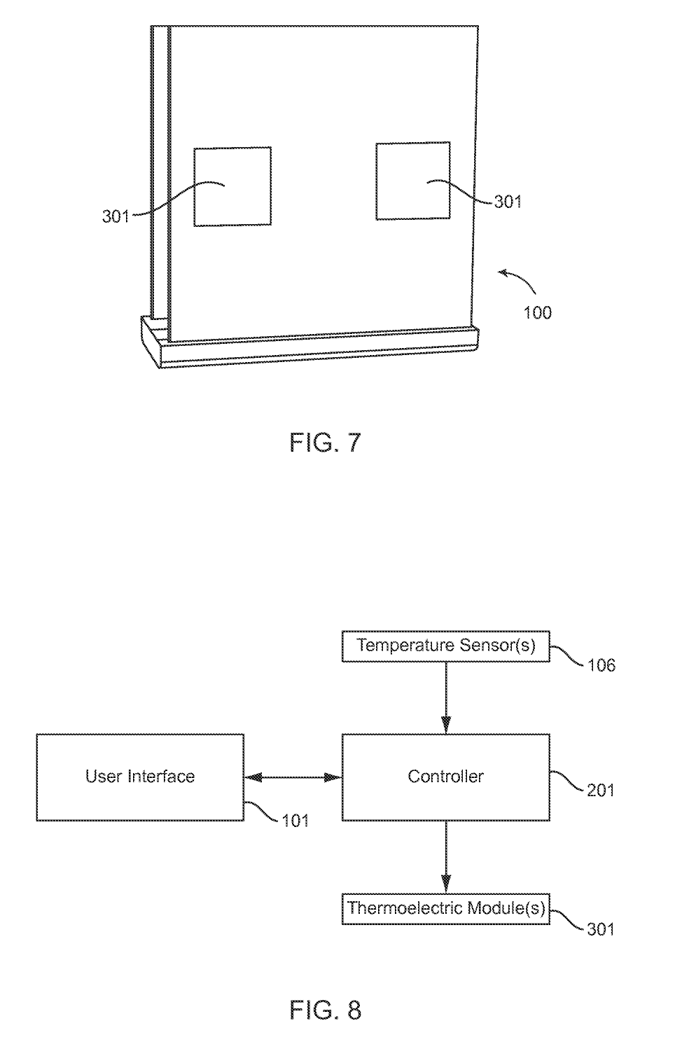

Heat transfer from/to the heating/cooling elements to/from the cooking surfaces can be done using direct contact, as shown in FIG. 7. Alternatively, heat pipes can be used to separate the heating/cooling elements from the cooking surfaces.

Information that the controller (mounted on the board labeled 201) can use to determine the correct amount of heating or cooling to apply includes: temperature above or below safe thresholds, food internal temperature (e.g. from a probe inserted into the food), food-cooking surface interface temperature (in one or more locations), cooking surface internal temperature (in one or more locations), food safety risks, temperatures in multiple cooking chambers (which may allow for coordination to increase efficiency), knowledge about the food itself (e.g. chicken breast at 1.5″ thick) and desired result (e.g. medium rare) and combinations of these data such as absolute differences and gradients (e.g. slowing down the rate of power delivery as the difference between cooking surface temperature and food internal temperature narrows).

The controller 201 is advantageous in that it enables food temperature to vary minimally from TT. As a consequence, the cooking surface temperature will also have a minimum of variance from the TT. The controller 201 can alternatively be used to precisely control the cooking surface temperature at TT. Further, the controller 201 can be used to establish a safe THold via control of the cooking surface temperature, including chilling the cooking surfaces to hold the food at a safe, refrigerated temperature.

The controller 201 can also use a programmed recipe, such as holding a high temperature for a time, then moving to a lower temperature, and finally moving to a final holding temperature (e.g. for custard). Some of this information may be encoded on the food item's packaging and be readable by the device. Encoding mechanisms could include bar codes, QR codes, and RFID tags. A system diagram of a control setup using only temperature sensors for input and thermoelectric modules for output is shown in FIG. 8.

The appliance 100 can additionally comprise one or more microprocessors and memory for storing various computer-readable instructions / software. The appliance 100 can include a wired or wireless transceiver allowing it to receive/transmit data remotely and/or to be controlled remotely (i.e., a remote computer, tablet, mobile phone, and the like can change one or more operational parameters of the appliance 100 via the controller 201). Software updates can be downloaded via the transceiver as well as other types of information such as recipes, and the like.

The interface 101 can be used not only to provide information about the food 107 being cooked such as internal temperature, time to completion until reaching the desired temperature, elapsed time, and the like, but it can also be used to provide guidance to the user about the cooking process. The interface 101 can provide step-by-step guidance regarding particular recipes, cuts of meat/fish, and the like. Such guidance can be stored locally in the memory and/or it can be accessed from a remote data source via the transceiver.

One embodiment of the invention relates to human computer interface, specifically with that interface being a touch screen computer, a touch-screen mobile device or tablet.

According to preferred embodiments, the invention relates to culinary arts, preferably cooking methods and cooking systems.

The invention relates to the use of surrogate objects on the touch screen that the user manipulates to represent how they want the real world object to be and/or a system or method to perform. Preferably, allowing one or more users to manipulate a surrogate or photo on a touch screen (e.g., on a computer interface, tablet or mobile device) or use other gestures to control or alter a method or process relating to one or more product(s) being manufactured, treated or otherwise processed.

For example, sliding your finger or a mouse to the left may make a photograph or other representation of a steak appear more rare, as well as setting a cooking device so that when it subsequently cooks the real steak, the real steak will also be cooked more rare. Sliding your finger up may make the crust on the representation of the steak appear thicker, with, again, the cooking device applying sufficient searing heat for sufficient time to match the representation. Pinching may cause, for example, a change from flat-gradient to bull's eye gradient.

According to preferred embodiments, the interface brings the background image completely into the foreground, with the user acting directly upon it, rather than using the intermediary of control panels.

Preferably, the appropriate control may appear when a user begins doing a given gesture so the user knows more precisely what range they're in and what temperature, time, or other parameter they're selecting. Alternately, an information object showing the current state of the parameter may appear. Alternately, more than one information object may appear or persist, including the full set of information objects.

The control or information object for Doneness might, for example, upon the finger sweeping sideways, display the current state—medium rare—and current temperature—133 degrees Fahrenheit—chosen. Our interpretation of their sweep would enable fine control when first moving, accelerating if the user moves faster or further. If the user wants to change 133 degrees to 134, the user would have that control implemented by sweeping perhaps a half inch to the right. Sweep more rapidly and/or farther, however, and you'd quickly enter medium, medium-well, etc. In use, the user would sweep to the general area, pause finger, then sweep back or forth to hit the exact mark if the user wants a different temperature.

The interface allows for the selection of broad zones, and within those zones, more precise selections. For example, as the user sweeps right, the pointer sweeping with them might pause over the exact center of medium-rare long enough to react if they want the standard setting. Moving further would again begin to register temperature changes.

Zone jumping could also be made easier by having the acceleration slow close to a stop when the user achieves the ideal temperature within a zone, with the object changing color to indicate the user is at the normal temperature for that zone.

Another embodiment of the invention relates to a method for programming the subsequent behavior or altering the current behavior of a device by displaying a photographic representation typical of the object as a surrogate for the object and enabling users to directly manipulate the surrogate object until the controllable characteristics of the surrogate object appear as they want the real-world object to appear.

Another embodiment of the invention relates to a method for enabling users to customize a product by displaying a surrogate of the product and enabling users to directly manipulate or issue voice commands to alter the surrogate object until the controllable characteristics of the surrogate object, for example, dimensions, color, style, etc., appear as they want the real-world object to appear.

FIG. 10A-D depicts a gesture set according to a preferred embodiment of the invention. FIG. 10A depicts a double-tap gesture on the center of the screen to make the control overlays fly off or snap off. Preferably, a second double-tap makes them return. FIG. 10B depicts a sweeping of the finger left and right to change the degree of doneness of the steak in the illustration, with the change taking place continuously as the finger is swept. FIG. 1 OC depicts a sweeping up and down which preferably also displays the thickness of the crust increasing and decreasing. Preferably, the crust changing is depicted using an inset blow-up (not shown) of just one corner of the steak to enable the user to properly judge the crust changes. FIG. 1 OD depicts pinching two fingers together and preferably displays the bull's eye, while pulling two fingers apart results in the bull's eye turning into a flat gradient. According to preferred embodiments, shaking the tablet (or “scribbling” on the touch screen interface) will “Undo” the settings.

Another embodiment of the invention relates to a computer-based system for processing one or more products comprising:

a) a display for displaying one or more images relating to said one or more products;

b) an interface for receiving gestures or input from a user;

c) a controller configured to receive instructions from said interface and control a processing subsystem for processing said one or more products.

Preferably, the processing subsystem is a cooking device.

Preferably, the processing subsystem manufactures or processes the one or more products.

Preferably, the one or more products are food.

Preferably, the display and the interface are provided by a touch screen which can both display the images and receive input from users.

Preferably, wherein the one or more images are surrogates of the one or more products. More preferably, the interface receives gestures or other inputs by a user manipulating the one or more images.

According to another preferred method and system, when receiving a valid request such as a gesture or mouse movement or voice command, the method or system preferably carries out two actions:

1) updating the surrogate image to indicate to the user the effect their current action will have on the real object; and

2) updating the request that will be sent to the controller.

Step 2 may occur with each detected change or only when a given sequence of changes, such as a gestural sweep or a mouse movement is completed or when a complete set of user instructions is provided.

Step 1 may also occur with each detected step or only when a given sequence of changes, etc. occurs. Preferred methods and systems may also update the user's preference in a database to aid the computer in predicting the user's subsequent preferences.

According to the preferred embodiments of the invention, the tying together of the surrogate and the real object provides advantages by simplifying the user interface for operating such systems and methods, allowing greater flexibility and efficiencies by integrating user preferences with computer-based processes and providing customizable solutions in cooking, food processing, manufacturing, treatment and related processes.

Another aspect of the invention relates to a computer based system configured for performing any of the methods of the invention described herein.

One embodiment relates to a computer based system comprising at least one computer device comprising at least one processor coupled to the memory, and also coupled to the one or more sensors, the memory having computer readable code, which when executed by the processor causes the computer based system to perform the methods described herein.

Another embodiment relates to a non-transitory computer readable medium including instructions that, when executed by a processing device, cause a cooking appliance to perform any of the methods described herein.

Various aspects of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, functional programming language, logical programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and an interface such as a touch screen and/or a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in and/or include a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. Other embodiments may be within the scope of the following claim.

With respect to the appended claims, unless stated otherwise, the term “first” does not, by itself, require that there also be a “second”. Moreover, reference to only “a first” and “a second” does not exclude additional items (e.g., sensors). While the particular devices, computer-based systems and methods described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

1. A method of cooking a food to a desired doneness gradient using a heat source that is modulated during the cooking.

2. The method of claim 1, wherein the modulation is determined by the current temperature at the food's surface, the food's internal temperature at one or more points, heat transfer within the food, or some combination thereof and the desired doneness gradient, said modulation being controlled by a control unit supervising the heat source.

3. The method of claim 1, wherein the resulting cooked food has a flat gradient of doneness such that the resulting cooked food has the same or substantially the same amount of doneness throughout.

4. The method of claim 1, wherein the modulation is designed to produce the doneness gradient selected by a user.

5. The method of claim 1, further comprising receiving a selected cooking gradient request from a user and modulating the cooking based on said request to result in said selected cooking request.

6. The method of claim 1, wherein said cooking is done without a water bath or added steam or bag.

7. The method of claim 1, wherein said heat source is selected from the group consisting of microwave cooking source, induction cooking source, radiant heat source or resistive heater.

8. A method of cooking a food to a desired doneness gradient using a heat source that is controlled to modulate the cooking wherein:
(i) the source delivers energy to said food to increase the surface of the food to a desired temperature;
(ii) the delivery of said energy is paused or reduced for a sufficient time to allow surface energy to migrate into the food through conduction and allow the surface to cool to the target temperature or less; and
(iii) steps (i) and (ii) are repeated until the center of the food has reached the target temperature.

9. The method of claim 8, wherein said cooking is performed using a cooking device and said cooking device determines when the center of the food has reached the target temperature.

10. The method of claim 8, wherein the cooking device is a contact grill.

11. The method of claim 8, wherein the cooking device is an oven or single-sided grill/griddle.

12. The method of claim 8, further comprising searing the food by delivering higher energy to the food to increase the temperature at the surface sufficient to result in searing.

13. The method of claim 8, further controlling the transmission of energy to the food so as to produce a range of desired cooking gradients, ranging from a flat doneness gradient to a graded gradient, with the outside surfaces cooked more than the center, resulting in a bulls eye or v-shaped doneness gradient, or any variant as desired by the cook.

14. A method of cooking wherein:
(i) a time period desired for a requested doneness gradient is provided by a user; and
(ii) an energy source for the cooking is modulated to optimize the cooking within the time period to result as close as possible to the requested doneness gradient.

15. The method of claim 14, wherein the time period selected is longer than necessary for the food to achieve the requested doneness gradient and said method comprises lowering the temperature of the energy source and resulting internal temperature of the food until a short period of time before the end of said time period and subsequently raising the temperature of the energy source so that the food reaches a target doneness and gradient within the time period.

16. The method of claim 14, wherein said time period selected is longer than necessary for the food to achieve the requested doneness gradient and said method comprises lowering the temperature of the energy source and resulting internal temperature of the food after the food has reached the target doneness and gradient and holding the temperature until said time period is finished.

17. The method of claim 14, further comprising searing the food by cooling the food to an internal temperature below the target doneness and thereafter increasing the heating source to allow for searing of the surface of the food without overheating the inside of the food.

18. The method of claim 14, comprising overheating the surface during the time the food's internal temperature is below target temperature to boost the heat conduction in the early cooking stages.

19. The method of claim 14, further comprising lowering the temperature of the food if the specified cooking completion time is exceeded to stabilize the food at a lower temperature until the cooking is turned off.

20. A method of controlling the cooking of the food in a device using a modulated heat source to achieve the optimum gradient of doneness and/or tenderness given the time specified using an algorithm utilizing one or more of the following parameters:
(i) type of food;
(ii) food toughness;
(iii) thickness and/or shape of food;
(iv) moisture level of the food;
(v) fat content of the food;
(vi) any other physical property of the food;
(vii) requested doneness of the food;
(viii) requested tenderness of the food
(ix) time available for cooking;
(x) starting temperature of the food;
(xi) whether searing will to be done, and if so, whether at the start or end or both start and end of the cooking cycle;
(xii) requested cooking duration; and
(xiii) pre-determined cooking contour.

21. The method of claim 20, wherein said control unit determines a cooking contour using a database of foods.

22. The method of claim 20, wherein said database is stored off the device.

23. The method of claim 20, wherein said database is stored in the device.

24. A cooking appliance for cooking food comprising:
(a) a cooking chamber;
(b) a heating source;
(c) one or more sensors to measure: (i) food characteristics, (ii) the state of the cooking elements, and (iii) the state of the food including temperature;
(d) an interface adapted to receive input from a user; and
(e) a computer-based unit configured to implement an algorithm for supervising operation of the heating source.

25. The cooking appliance of claim 24, wherein said algorithm determines a cooking contour using a database of food.

26. The cooking appliance of claim 24, wherein said algorithm determines a cooking contour based on a user's manual entry of cooking time, doneness gradient and food.

27. The cooking appliance of claim 24, further comprising a display for the interface.

28. The cooking appliance of claim 24, further comprising controls and a display for the interface that are located remotely from the cooking appliance, connected by wires, infra-red, or by a wireless (radio) connection.

29. A computer-implemented method for cooking a food performed by using the cooking appliance of claim 24 including at least one processor coupled with a memory, the method comprising:
(a) receiving a cooking request from a user using controls on the appliance or transmitted from an external computer-based device;
(b) determining whether one or more rules associated with the cooking request apply;
(c) processing the cooking request if all rules determined to be applicable are satisfied; and
(d) denying the cooking request if one or more rules determined to be applicable are not satisfied;
wherein the processing comprises:
(i) analyzing the cooking request to determine a user's preferences; and
(ii) generating recommended cooking contours and gradient of doneness based on the food and the user's preferences.

30. The method of claim 29, further comprising cooking the food based on the recommended cooking contours and doneness.

31. The cooking appliance of claim 24, wherein said one or more sensors are incorporated into the controller and said one or more sensors measure parameters selected from the group consisting of:
(a) coil currents for resistive and/or inductive heating elements;
(b) cooking plate temperatures;
(c) food temperature at various locations along the food and/or within at various depths (spec:, such as surface and center temperatures);
(d) thickness of the food;
(e) food weight detector;
(f) steam detector;
(g) smoke detector;
(h) humidity sensor;
(i) plate force sensor;
(j) light transmissivity sensor; and/or
(k) acoustic sensor.

32. A computer based system configured for performing any one of the methods of claims 1-31, comprising at least one computer device comprising at least one processor coupled to the memory, and also coupled to the one or more sensors, the memory having computer readable code, which when executed by the processor causes the computer based system to perform the method.

33. A non-transitory computer readable medium including instructions that, when executed by a processing device, cause a cooking appliance to perform any one of the methods of claims 1-32.

34. The cooking appliance of claim 24, wherein said algorithm operates the controller to supervise operation of the heating source to permit one of the following modes of operation:
(i) when the user provides a shortened time period less than a traditional time period for said food, a cooking temperature contour is selected and implemented to produce best compromise food within the shortened time period;
(ii) when the user provides a requested time period equal to or substantially equal to a traditional time period for said food, a traditional cooking temperature contour is selected to cook the food within the requested time period;
(iii) when the user provides an intermediate time period between the traditional time period for said food and a time period sufficient for flat-gradient cooking of said food, a cooking temperature contour is selected and implemented so that the internal temperature of the food reaches a target temperature within the intermediate time period with a doneness gradient as close as possible to a flat gradient;
(iv) when the user provides a requested time period equal to or substantially equal to a flat gradient time period, the food is cooked at a target temperature; and
(v) when the user provides a requested time period greater than a flat gradient time period, a cooking temperature contour is selected so that internal temperature of food is lowered sufficiently to prevent overcooking, with the contour ensuring the food is at the best possible temperature within the requested time period for either searing or serving.

35. A cooking appliance for cooking food comprising a cooking chamber capable of being sealed during cooking to prevent a temperature drop at the open sides of the food due to radiation and/or air flow.

36. The cooking appliance of claim 35, further comprising heating elements configured to transfer heat directly into the cooking chamber in order to cook the food.

37. The cooking appliance of claim 35, wherein said cooking chamber is a rectangular or oval-shaped vessel.

38. The cooking appliance of claim 35, further comprising heating elements configured to directly heat the food through conduction.

39. The cooking appliance of claim 35, further comprising a flat-plate heat source at the bottom of the cooking chamber.

40. The cooking appliance of claim 39, further comprising a vertically adjustable flat-plate heat source or a fixed-height or adjustable-height radiant heat source at the top of said cooking chamber.

41. The cooking appliance of claim 39, wherein said cooking chamber further comprises a hinged top.

42. The cooking appliance of claim 39, wherein said cooking chamber further comprises a front door to load and remove food.

43. The cooking appliance of claim 39, wherein said cooking chamber comprises adjustable walls capable of being adjusted to contact the food.

44. The cooking appliance of claim 39, wherein said adjustable walls are removable.

45. The cooking appliance of claim 39, wherein said adjustable walls allow liquid to pass.

46. The cooking appliance of claim 39, further comprising one or more bottom and/or top plates.

47. The cooking appliance of claim 39, wherein at least one of said plate(s) can be individually adjusted to contact the food.

48. The cooking appliance of claim 39, wherein said plate(s) are removable.

49. The cooking appliance of claim 39, wherein said plate(s) are shaped for one or more specific foods or food types.

50. The cooking appliance of claim 39, wherein the bottom plate(s) form a vessel capable of holding a liquid.

51. A cooking appliance for cooking food comprising a cooking chamber configured to prevent loss of cooking heat through radiation and/or air flow.

52. A cooking appliance for cooking food comprising a cooking chamber comprising a skirt around one or more open sides of the food and configured to prevent a temperature drop at the open sides of the food due to radiation and/or air flow.

53. A cooking appliance for cooking food comprising a cooking chamber comprising at least one skirt configured to prevent loss of heat through radiation and/or air flow.

54. A cooking appliance for cooking food comprising a cooking chamber comprising two or more heating elements to heat two or more direct heating sides of said food and a skirt configured to surround two or more open sides of said food to prevent loss of heat through radiation and/or air flow.

55. A cooking appliance with two or more heating elements with a precision electronic controller configured to cook food to a precise internal target temperature with a flat doneness gradient, comprising one or more temperature sensors configured to be placed adjacent, near and/or in the food so that the controller ensures that the food uniformly reaches said precise internal target temperature.

56. The cooking appliance of claim 55, further comprising a controller configured to interact with and/or control (i) two or more heating elements; (ii) one or more cooling elements; and/or (iii) said one or more temperature sensors.

57. The cooking appliance of claim 55, further comprising at least two opposing cooking surfaces heated by said two or more heating elements.

58. The cooking appliance of claim 55, wherein said appliance is configured to keep the food both before and after cooking at desired holding temperatures.

59. The cooking appliance of claim 55, wherein said two or more heating elements may be in a horizontal, vertical, an angle or other orientation.

60. A computer based interface system for specifying the desired properties of a prepared item such as cooked food by manipulating an onscreen surrogate for said food, wherein said surrogate changes to indicate the properties desired.

61. The system of claim 60, wherein the surrogate is manipulated using one or more of a mouse, touchscreen, or voice interface.

62. The system of claim 60, wherein the change in the values of the properties being manipulated jumps to the recommended value when a large motion is made to indicate a new zone, such as “medium rare” but further manipulation results in smaller changes to allow increased precision.

63. The system of claim 60, wherein a cooking device executes a cooking process to create food with the desired properties.

64. A computer based system configured for performing any one of the methods of claims 1-63, comprising at least one computer device comprising at least one processor coupled to the memory, and also coupled to the one or more sensors, the memory having computer readable code, which when executed by the processor causes the computer based system to perform the method.

65. A non-transitory computer readable medium including instructions that, when executed by a processing device, cause a cooking appliance to perform any one of the methods of claims 1-65.
